(19) United States
(12) Patent Application Publication
(10) Pub. No.: US 2019/0244193 A1
(43) Pub. Date: Aug. 8, 2019

(54) Classical wallet

(71) Applicants: Miguel A. Ascarrunz, Dallas, OR (US); Anita G. Ascarrunz, Dallas, OR (US)

(72) Inventors: Miguel A. Ascarrunz, Dallas, OR (US); Anita G. Ascarrunz, Dallas, OR (US)

(21) Appl. No.: 15/932,117

(22) Filed: Feb. 7, 2018

(51) Int. Cl. G06Q 20/36; G06Q 20/14; G06Q 40/00; G06Q 20/32

(52) U.S. Cl. CPC G06Q 20/363; G06Q 20/3223; G06Q 40/12; G06Q 20/14

(57) ABSTRACT

A plurality of these “Classical Wallets” which function as a mini-bank. “If there are assets in the “Classical Wallet”, you won't need to use a bank”. Anyone can make a financial transaction at any time. The requirements will be downloaded into a plurality of electronic devices, like a smart phone, iPhone, iPad or computer connected to the internet. The physical presence of credit/debit cards and personal documents will be downloaded electronically to the “Classical Wallet”. Also, the “Classical Wallet” can be used as a system and method for conducting E-commerce via the interact in any environment.

The “Classical Wallet” will have a drop-down menu. The menu will be divided into a plurality of at least seven (7) sections.

The “Classical Wallet” will function as a mini-bank; anyone can make a financial transaction at any time. Banks will have to change with the advance of technology.

The requirements will be downloaded into any electronic device, smart phone, iPhone, iPad or computer, connected to the internet.
The physical presence of credit/debit cards and personal paper documents will be downloaded on the “Classical Wallet” electronically.
Smart phones are computers used to make credit/debit payments contactless. These computers are not utilized the way they should, the advance of technology will increase their output 100% and that is the reason for this invention.

Directions on the “Classical Wallet” will be user-friendly and read in most used languages.

### CROSS REFERENCE TO RELATED APPLICATION

Cross-references to other related applications: US Patent Documents:
U.S. Pat. No. 9,015,066 Digital wallet loading
U.S. Pat. No. 8,776,132 Single digital wallets across multiple payment platforms
U.S. Pat. No. 8,701,982 Gift card conversion and digital wallet
U.S. Pat. No. 8,511,543 Gift card conversion and digital wallet
U.S. Pat. No. 8,459,560 Converting digital wallet credential from displayed code into audio code
U.S. Pat. No. 8,938,402 Methods and apparatus for conducting electronic transactions
U.S. Pat. No. 8,924,310 Methods and apparatus for conducting electronic transactions
U.S. Pat. No. 8,768,834 Digital exchange and mobile wallet for digital currency
U.S. Pat. No. 8,734,236 Player wagering account and methods thereof
U.S. Pat. No. 8,559,639 Method and apparatus for secure cryptographic key generation, certification and use
U.S. Pat. No. 8,523,054 Gift card conversion and digital wallet
U.S. Pat. No. 8,515,860 System, method and computer program product for prepaid and wireless voice Communication and IP
U.S. Pat. No. 8,401,898 System and method for using loyalty rewards and currency
*U.S. Pat. No. 8,393,955 Player wagering account and methods thereof
*U.S. Pat. No. 8,265,993 System and method for using loyalty rewards as currency
*U.S. Pat. No. 8,214,299 Methods and apparatus for conducting electronic transactions
*U.S. Pat. No. 8,046,256 System and method for using loyalty rewards as currency
U.S. Pat. No. 7,962,409 Method and system for processing internet payments using electronic funds transfer network
U.S. Pat. No. 7,801,829 Smartcard internet authorization system
*U.S. Pat. No. 7,801,827 Methods and apparatus for conducting electronic transactions
*U.S. Pat. No. 7,366,703 Smartcard internet authorization system
*U.S. Pat. No. 7,346,587 Intelligent method of order completion in an e-commerce environment based on availability of stored billing information
*U.S. Pat. No. 7,343,351 Methods and apparatus for conducting electronic transactions
*U.S. Pat. No. 7,328,350 Method and apparatus for secure cryptographic key generation, certification and use
*U.S. Pat. No. 6,956,950 Computer readable medium having a private key encryption program
*U.S. Pat. No. 6,928,623 Method and system for selecting a target window for automatic fill-in
*U.S. Pat. No. 6,704,714 Virtual private lock box
*U.S. Pat. No. 6,609,113 Method and system for processing internet payments using electronic funds transfer network
*U.S. Pat. No. 6,170,058 Method and apparatus for cryptographically camouflaged cryptographic key storage, certification and use
*U.S. Pat. No. 8,827,154 Verification of portable consumer devices

*These patents have many derivations not listed here.

### STATEMENT OF FEDERALLY SPONSORED RESEARCH/DEVELOPMENT

There are no rights to this invention that was made under federally sponsored research and development.

### NAMES OF THE PARTIES TO A JOINT RESEARCH AGREEMENT

Name of the Inventors:

Miguel A. Ascarrunz, US citizen, resident of the State of Oregon, USA
Anita G. Ascarrunz, US citizen, resident of the State of Oregon, USA

### REFERENCE TO A SEQUENCE LISTING

“Not applicable”.

### BACKGROUND OF THE INVENTION

This invention is original, and clearly describes how it effectively eliminates unnecessary paper work. We claim it as a Utility patent which protects the way an invention is used and how it works paraphrasing the applicable US patent classification definition. “Utility patents may be granted to anyone who invents or discovers any new and useful process, machine, article of manufacturer, composition of matter, or any useful improvement thereof”.

The invention of the “Classic Wallet” is a new step forward in making any commercial transaction more efficient, convenient and with lots of savings for the credit card companies and consumers. By the end of fiscal year 2015, a total of more than 700 million smart phones were sold. With this market growing exponentially, most people in the world will have a device like a smart phone, iPhone or iPad soon. Companies will charge for the services to anyone using the “Classical Wallet” as well as the merchant users of any of the services offered.

Up until now, anything discovered has not been proven to resemble the way this invention works. Research of prior art has not come out with anything resembling how this invention operates.

### BRIEF SUMMARY OF THE INVENTION

The “Classical Wallet” will function as a mini-bank; anyone can make a financial transaction at any time. The requirements will be downloaded into any electronic device like a smart phone, iPhone, iPad or computer connected to the internet.

The physical presence of credit/debit cards and personal paper documents will be downloaded on the “Classical Wallet” electronically.
The “Classical Wallet” will function when the proper secret codes assigned are entered or by voice recognition.
Each one of the (7) sections will only open with voice recognition or a digital impression (thumb print) of the owner, applied to the face of the “Classical Wallet”. The thumb print is required to open the respective sections of the “Classical Wallet” and it will not be transmitted to anyone. It is a system and method for conducting E-commerce via the internet in any environment. This includes both, scanned transactions and key-entered transactions. The electronic transaction with the “Classical Wallet” is a purchase transaction as well as an account of all bank transactions and payments in periodical pre-set periods by the credit companies. Every credit/debit card or personal document contains a unique design feature and security elements to help issuers of this document, owners of the document and merchants to verify the digital credit/debit cards and personal documents' legitimacy.

### BRIEF DESCRIPTION OF THE SEVERAL VIEWS OF THE DRAWINGS

Fig. No figures.

### DETAILED DESCRIPTION OF THE INVENTION

The “Classical Wallet” will function as a mini-bank. “If there are assets inside the “Classical Wallet”, you won't need a bank”. Anyone can make financial transactions at any time. The requirements will be downloaded into any new electronic device, smart phone, iPhone, iPad or computer connected to the internet.

The physical presence of credit/debit cards and personal paper documents will be downloaded on the “Classical Wallet” electronically.
The “Classical Wallet” will function when the proper secret codes assigned are entered or by voice recognition.
It is a system and method for conducting E-commerce via the internet in any environment. This includes both, scanned transactions and key-entered transactions. The electronic transaction with the “Classical Wallet” is a purchase transaction as well as an account of all bank transactions and payments in periodical pre-set periods by the credit companies. Every credit/debit card or personal document contains a unique design feature and security elements to help issuers of this document, owners of the document and merchants to verify the digital credit/debit cards and personal documents legitimacy.
Companies offering the “Classical Wallet” will charge for the services to anyone using it as well as to the merchants.
Banks, as we know them now, will basically have to change because of this innovation.

The “Classical Wallet” will have a drop-down menu. The menu will be divided into seven (7) sections:

a) Assets (income), Debits (payments) and investments

b.) Credit or Debit digital cards and Loan Companies

c.) Record payments to the issuer of the credit/debit digital card

d.) Monthly credit scores from the Credit companies

e.) Personal documents issued by local State or Federal Government

f.) Health history records and nutrition,

g.) Pictures/Multimedia

Each one of these (7) sections will only open with voice recognition or the digital impression (thumb print) of the owner, applied to the face of the “Classical Wallet”. The thumb print is required to open the respective sections of the “Classical Wallet” and it will not be transmitted to anyone. The owners' thumb print is unique for each “Classical Wallet”. If the personal “Classical Wallet” is lost, all data can be deleted or, if found, re-instated wireless. The owner will be assigned a USB memory stick (works for a unique device) for future record keeping and storage.

### a) Assets (Income), Debits (Payments) and Investments:

The assets (income) will show the balance in the checking and savings accounts daily. These records will be sent to the “Classical Wallet” by the bank or authorized organizations, making deposits to the unique “Classical Wallet”.

The debits (payments) will show any outstanding statements daily and at closing. It will show record of payments.

Example and record of monthly payments:

### January 2018

| | | | | |
|---|---|---|---|---|
| Bills | Amount due | Due date | Date paid | Balance |

Mortgage/rent
Mortgage principle
HOA
Car Payment
Prescriptions
Water
Electricity
Gas
Garbage
Telephone
TV
Internet
American Express
Visa
Master Card
Discover

### Yearly Record of Payments

| | | | | |
|---|---|---|---|---|
| Bills | Amount due | Due date | Date paid | Balance |

Health Ins.
Dental Ins.
Home Ins.
Car Ins.
Taxes

The above payments reflect the average household expenditures for an average family. When a payment is executed via an “automated bank deduction” or debit card, this action will be entered in the “date paid” column in such a way that anyone will know which payments have been executed and any balance on the account.
Upon request, any of the bills listed can be reclaimed to show all details of the accounting of the monthly statements. The monthly statements can be kept up to one (1) year in the “Classical Wallet”. After that it can be downloaded into a personal computer or on a USB flash drive.

Investment firms will give lessons of personal finance; (e.g. “what is marketing”: targeting a section of the market, positioning the offering, buying, selling in the stock market, how to be a “day trader”, and learn about the bond and futures markets). It will give you all the advice you need to invest and make money for retirement. All these features will be available inside the “Classical Wallet” for your service.

### b.) Credit or Debit Digital Card and Loan Companies

The owner of the “Classical Wallet” will apply for opening an account to a financial institution. Once approved, it will also show the details in the “Classical Wallet” and then, the owner of the “Classical Wallet” can proceed to apply for a credit/debit card. Once approved by the financial institution, the credit/debit card will show in the owners' “Classical Wallet” as a virtual digital credit/debit card. The authorized digital card will show a picture (optional), name, age and a barcode. The barcode will show any details that the bank or the credit store wants to install in the barcode for security. A barcode is an optical machine-readable representation of data which shows data about the object to which it attaches. In point-of sale management, barcode systems can provide detailed up-to-date information on the business, accelerating decisions and with more confidence.

The security will prevent to transfer this credit/debit digital card into a different device than the one it was intended for. The creditor, at his discretion, can remove the card from the “Classical Wallet”.

The owner of the new approved “Classical Wallet”, which is an electronic device like a smart phone, iPhone or iPad computer that has the digital credit/debit digital card installed in it will open a drop-down menu that shows the seven (7) sections for which it is designed. Pick section (b) listed as “Credit or Debit Digital Card and Loan Companies”. This section listed above (b) opens with voice recognition or the thumb print of the owner plus a secret code, assigned by the owner.

From that menu section (b) you can choose the credit/debit digital card of your choice. Once decided, you must input another secret number in the “Classical Wallet” in order to open the respected debit/credit card or use voice recognition.
This Credit card will keep track of all the monthly transactions and will also always show the total daily expenditures, as well as the balance on the account.

Merchants will be assigned a proper portable scan-device that will record the transaction from the owner of the “Classical Wallet”. The merchant that wants to collect the sum of the transaction initiated by the owner of the “Classical Wallet” will use a scanner and will scan the barcode of the smart phone. Immediately, an approval or disapproval of such a transaction will show. There is no need for paper receipts of transactions or the use of approval signature. The creditor will financially complete the transaction and subsequently bill electronically the respective card issuer and respectively to the owner.

Every “Classical Wallet” will come with an USB Memory Stick which is programmed to only work with the specific “Classical Wallet”. When the “Classical Wallet” is filled with the information (Credit Card or other documents) all of that information should be backed up on the USB Memory Stick for future use in the event that the “Classical Wallet” is lost or stolen. The stored information in the “Classical Wallet” will be erased with a certain command. At such a time the USB Stick can be loaded into a new issued “Classical Wallet”.

In an e-commerce era more and more people are purchasing items over the internet. These purchases will be possible with the “Classical Wallet” because each “Classical Wallet” will be issued with a scanner. When a person wants to pay with a credit/debit digital card that person can scan that electronic credit/debit digital card and proceed to purchase any item with the acceptance of the credit or debit card issued through a bank. Each scanner is unique and will only work for a unique “Classical Wallet”. The scanner will not work with any other “Classical Wallet”. After a purchase with the “Classical Wallet”, the merchant will sent an electronic receipt to your device.

### c.) Record of Payments to the Issuer of the Credit/Debit Digital Card

When the due date comes, the statement will also reflect the amount due. The customer can pay-off the credit issuer from his bank account inside the “Classical Wallet”. The above method described will be used repeatedly in the same manner for any purchase with a credit or debit card.

This is what describes the elimination of the regular visits to a bank, or pay the creditors, using other means. With payments on line throughout this unique method, the transaction will be secure, using the “Classical Wallet”.

d.) Monthly Credit Scores from the Credit Companies

The new electronic device will also be able to receive the monthly credit scores for the recipient of the “Classical Wallet”. Owners of the “Classical Wallet” who maintain a credit score above “800” can have their own credit cards without using any credit institutions.

### e.) Personal Documents Issued by Local State or Federal Government

When a local State or the Federal Government issues a document, (e.g. Drivers' License, Social Security card, Medicare Card, Passport, Birth Certificate, Marriage License, Divorce Certificate, Food Market Credit Card or any other Security document), all these documents in scripted will be secure inside the “Classical Wallet” because no one can duplicate them; instead of a “paper copy” that anybody can duplicate. In time, as more and more people use the “Classical Wallet”, the hard copy documents will phase out. Every time there is a change to one of the documents in the “Classical Wallet”, a new paperless document will be issued.

### f.) Health History Records and Nutrition

All health records, Immunization records, lab- and test results will be recorded the minute you see a doctor and any action done by the health provider will be inputted into the record of the owner of the “Classical Wallet”.

### g.) Pictures/Multimedia

This section will also show a multi-media phone, text input and all the functions of a smart phone, iPhone or iPad will be included.

Multimedia is a technique (as the combining of sound, videos, graphics and text) for expressing ideas (as in communication, entertainment or art) in which several media are employed. Also, it can be something (as in software) using or facilitating such a technique.

1. We claim plurality of these “classical wallets” which function as a mini-bank: “If there are assets in the “Classical Wallet”, you won't need to use a bank”. Anyone can make a financial transaction at any time. The requirements will be downloaded into a plurality of electronic devices, like a smart phone, iPhone, iPad or computer connected to the internet. The physical presence of credit/debit cards and personal documents will be downloaded electronically to the “Classical Wallet”. Also, the “Classical Wallet” can be used as a system and method for conducting E-commerce via the internet in any environment.
The “Classical Wallet” will have a drop-down menu. The menu will be divided into a plurality of at least seven (7) sections:
a.) Assets (income), Debits (payments) and investments. b.) Credit or Debit digital cards and Loan Companies. c.) Record payments to the issuer of the credit/debit digital card d.) Monthly credit scores from the Credit companies. e.) Personal documents issued by local State or Federal Government. f.) Health history records and nutrition. g.) Pictures/Multimedia
Each one of these (7) sections will only open with voice recognition, or the digital impression (thumb print) of the owner, applied to the face of the “Classical Wallet”. The owners' thumb print is unique for each “Classical Wallet”. In the event that the personal “Classical Wallet” is lost, the whole data can be deleted or, if found, re-instated wireless. The owner will be assigned a memory stick (works for a unique device) for future record keeping and storage.
The assets (income) will show the balance in the checking and savings accounts daily. These records will be sent to the “Classical Wallet” by the bank or authorized organizations, making deposits to the unique “Classical Wallet”.
The debits (payments) will show any outstanding statements daily and at closing. It will show record of payments.

| | | | | |
|---|---|---|---|---|
| Bills | Amount due | Due date | Date paid | Balance |

When a payment is executed via an “automated bank deduction” or debit card this action will be entered in the “date paid” column
Upon request, any of the bills listed can be reclaimed to show all the details of the accounting of the monthly statements.
Investments will give lessons of personal finance
The owner of the “Classical Wallet” will apply for opening an account to a financial institution Once approved, it will show the details in the “Classical Wallet” and then, the owner of the “Classical Wallet” can proceed to apply for a credit/debit card. Once approved by the financial institution. The credit/debit card will display in that owners “Classical Wallet” as a virtual digital credit/debit card. The authorized digital card will show a picture (optional), name, age and a barcode. The barcode will show any details that the bank or the credit store wants to install in the barcode for security.
This security will prevent to transfer this credit/debit digital card into a different device than the one it was intended for. The creditor, at his discretion, can remove the card from the “Classical Wallet”.
This Credit card will keep track of all monthly transactions and also will always show the total daily expenditures as well as the balance on the account.
Merchants will be assigned a proper portable scan-device that will record the transaction from the owner of the “Classical Wallet”. The merchant that wants to collect the sum of the transaction initiated by the owner of the “Classical Wallet” will use a scanner and will scan the barcode of the smart phone, iPhone or iPad. Immediately, an approval or disapproval of such a transaction will show. There is no need for paper receipts of transactions or the use of an approved signature. The creditor will financially complete the transaction and subsequently bill electronically the respective card issuer.
Every “Classical Wallet” will come with an USB Memory Stick which is programmed to only work with the specific “Classical Wallet”. When the “Classical Wallet” is filled with the information (credit card or other documents), all that information should be backed up on the USB Memory Stick for future use in the event that the “Classical Wallet” is lost or stolen.
The stored information in the “Classical Wallet” will be erased with a certain command. At such a time the USB Memory Stick can be loaded into a new issued “Classical Wallet”.
In an e-commerce era, more and more people are purchasing items over the internet. These purchases will be made possible with the “Classical Wallet” because each “Classical Wallet” will be issued a scanner.
Each scanner is unique and will only work for a unique “Classical Wallet”. The scanner will not work with any other “Classical Wallet”. After a purchase with the “Classical Wallet” the merchant will send an electronic receipt to your device.
The new electronic device will also be able to receive the monthly credit scores for the recipient of the “Classical Wallet”. Owners of the “Classical Wallet” who maintain a credit score above “800” can have their own credit cards without using any credit institutions.
When a local State or the Federal Government issues a document, (e.g. Drivers' License, Social Security card, Medicare Card, Passport, Birth Certificate, Marriage License, Divorce Certificate, Food Market Credit Card or any other Security document), all of these documents in scripted will be secure inside the “Classical Wallet” because no one can duplicate them; Every time there is a change to one of the documents in the “Classical Wallet”, a new paperless document will be issued right into your “Classical Wallet”.
All health records, Immunization records, lab- and test results will be recorded the minute you see a doctor and any action done by the health provider will be input in the record of the owner of the “Classical Wallet”.
This section will also show a multi-media phone, text input and all the functions of a smart phone, iPhone or iPad will be included.
